(19) United States
(12) Patent Application Publication
(10) Pub. No.: US 2015/0329090 A1
(43) Pub. Date: Nov. 19, 2015

(54) TRAVEL CONTROL APPARATUS AND VEHICLE CONTROL APPARATUS

(71) Applicant: TOYOTA JIDOSHA KABUSHIKI KAISHA, Toyota-shi (JP)

(72) Inventors: Ryochi WATANABE, Susono-shi (JP); Hiroshi OHMINE, Nisshin-shi (JP); Zensaku MURAKAMI, Susono-shi (JP)

(73) Assignee: TOYOTA JIDOSHA KABUSHIKI KAISHA, Toyota-shi (JP)

(21) Appl. No.: 14/700,983

(22) Filed: Apr. 30, 2015

(30) Foreign Application Priority Data
May 13, 2014 (JP) 2014-099931
Dec. 4, 2014 (JP) 2014-246241

(51) Int. Cl. B60T 7/12

(52) U.S. Cl. CPC B60T 7/12

(57) ABSTRACT

A travel control apparatus includes: a low speed travel apparatus that performs low speed travel control, in which a vehicle is caused to travel at a low speed, without the need for a driver to perform a braking/driving operation; a behavior control apparatus that permits vehicle behavior control in which a driving force applied to a vehicle wheel is reduced when an estimated vehicle speed equals or exceeds a permission reference value; and an amendment unit that amends the behavior control such that the driving force is less likely to be reduced during the behavior control by reducing the estimated vehicle speed when a specific condition, in which the estimated vehicle speed is highly likely to equal or exceed the permission reference value during execution of the low speed travel control even though an actual vehicle speed of the vehicle is lower than the permission reference value, is established.

### INCORPORATION BY REFERENCE

The disclosure of Japanese Patent Application Nos. 2014-099931 and 2014-246241, filed on May 13, 2014 and Dec. 4, 2014 including the specification, drawings and abstract, is incorporated herein by reference in its entirety.

### BACKGROUND OF THE INVENTION

1. Field of the Invention

The invention relates to a travel control apparatus for a vehicle, and more particularly to a travel control apparatus that performs low speed travel control and vehicle behavior control on a vehicle.

2. Description of Related Art

Low speed travel control is travel control performed to control a braking/driving force of a vehicle so that on an uphill slope or a downhill slope, the vehicle travels at a low speed (a creep speed) within a predetermined range without the need for a driver to perform a braking/driving operation. Japanese Patent Application Publication No. 2004-90679 (JP 2004-90679 A), for example, describes an example of a low speed travel control apparatus (a creep travel control apparatus) that performs low speed travel control. According to this low speed travel control apparatus, a vehicle can set off and travel easily and with stability even on a slope having a road surface with an extremely low frictional coefficient, in particular during off-road travel or the like.

Further, vehicle behavior control is travel control performed to stabilize travel behavior of a vehicle when the vehicle exhibits a spinning tendency or a drift-out tendency. In the vehicle behavior control, a driving force applied to a predetermined wheel and a vehicle speed are respectively reduced by applying a braking force to the vehicle wheel and/or reducing a vehicle driving force.

In a travel condition in which the low speed travel control is performed, a vehicle wheel speed that is least affected by braking, road surface resistance, and so on is closest to an actual vehicle speed, and therefore an estimated vehicle speed during the low speed travel control is typically calculated on the basis of a vehicle wheel speed (a highest vehicle wheel speed, for example) other than the lowest of a plurality of vehicle wheel speeds. Even when the low speed travel control is performed, driving slippage may occur in a vehicle wheel in a case where the vehicle travels uphill on a rugged slope having a road surface with an extremely low frictional coefficient. The vehicle wheel speed of the vehicle wheel in which driving slippage has occurred takes a much higher value than the vehicle wheel speed of the other vehicle wheels in which driving slippage has not occurred. As a result, the calculated estimated vehicle speed takes a much higher value than the actual vehicle speed.

Incidentally, when the vehicle speed is low, the vehicle is less likely to exhibit a spinning tendency or a drift-out tendency. In the vehicle behavior control, therefore, an unnecessary reduction in the driving force of the vehicle wheel is prevented by ensuring that the driving force is not reduced during the behavior control when the estimated vehicle speed is lower than a permission reference value.

### SUMMARY OF THE INVENTION

However, when driving slippage occurs in the vehicle wheel such that the vehicle wheel speed increases, the estimated vehicle speed may equal or exceed the permission reference value even though the actual vehicle speed is lower than the permission reference value. This situation is particularly likely to occur when driving slippage occurs in a plurality of vehicle wheels. As a result, it may be determined necessary to reduce the driving force of the vehicle wheels during the behavior control even though in actuality, a reduction in the driving force during the behavior control should not be permitted. Hence, the driving force may be reduced unnecessarily during the behavior control, leading to an unnecessary reduction in the vehicle speed even though the low speed travel control is underway, and as a result, a travel performance of the vehicle during the low speed travel control may deteriorate.

Note that likewise when the vehicle shifts from downhill travel to uphill travel, travels over a step or the like on the road surface, and so on, the driving force is increased at a high increase rate to ensure that the vehicle speed is maintained within the predetermined range during the low speed travel control, and therefore driving slippage is likely to occur in the vehicle wheels such that the estimated vehicle speed equals or exceeds the permission reference value. Further, when a responsiveness of a brake apparatus decreases, an unnecessary increase in the vehicle wheel speed cannot be suppressed with favorable responsiveness by braking performed during the low speed travel control, and therefore the estimated vehicle speed may reach or exceed the permission reference value.

An aspect of the invention provides travel control apparatus and vehicle control apparatus to reduce the likelihood of a reduction in driving force during behavior control in a condition where an estimated vehicle speed may equal or exceed a permission reference value during low speed travel control.

A travel control apparatus according to a first aspect of the invention includes: a low speed travel apparatus that performs low speed travel control, in which a vehicle is caused to travel at a low speed, by controlling a braking/driving force of the vehicle without the need for a driver to perform a braking/driving operation; a vehicle behavior control apparatus that calculates an estimated vehicle speed on the basis of a vehicle wheel speed, and performs behavior control to stabilize travel behavior of the vehicle by reducing a driving force applied to a vehicle wheel when stabilization of the travel behavior of the vehicle is determined to be required in a condition where the estimated vehicle speed equals or exceeds a permission reference value; a determination unit that determines whether or not a specific condition, in which the estimated vehicle speed is highly likely to equal or exceed the permission reference value during execution of the low speed travel control even though an actual vehicle speed of the vehicle is lower than the permission reference value, is established; and an amendment unit that amends the behavior control such that the driving force applied to the vehicle wheel is less likely to be reduced during the behavior control when the specific condition is determined to be established.

A vehicle control apparatus according to a second aspect of the invention includes: a low speed travel apparatus that performs travel control, in which a vehicle is caused to travel at a low speed, by controlling a braking/driving force of the vehicle; a vehicle behavior control apparatus that calculates an estimated vehicle speed on the basis of a vehicle wheel speed, and performs behavior control to stabilize travel behavior of the vehicle by reducing a driving force applied to a vehicle wheel when stabilization of the travel behavior of the vehicle is determined to be required in a condition where the estimated vehicle speed equals or exceeds a permission reference value; and an integrated control apparatus that determines whether or not a specific condition, in which the calculated estimated vehicle speed is highly likely to equal or exceed the permission reference value during execution of the low speed travel control even though an actual vehicle speed of the vehicle is lower than the permission reference value, is established, and amends the behavior control so that the driving force applied to the vehicle wheel is less likely to be reduced during the behavior control when the specific condition is determined to be established.

According to above aspects, when the specific condition is determined to be established, the behavior control is amended by the amendment unit such that the driving force applied to the vehicle wheel is less likely to be reduced during the behavior control. As a result, a situation in which the estimated vehicle speed is calculated to a value equaling or exceeding the permission reference value even though the actual vehicle speed is lower than the permission reference value such that the driving force applied to the vehicle wheel is reduced unnecessarily during the behavior control, leading to an unnecessary reduction in the vehicle speed and a corresponding reduction in a low speed travel performance of the vehicle, can be prevented from occurring.

In the aspects described above, the determination unit may be configured to determine whether or not the specific condition is established by determining whether or not the vehicle is traveling on an uphill road during execution of the low speed travel control.

According to this aspect, when the vehicle is determined to be traveling on an uphill road during execution of the low speed travel control, the behavior control is amended by the amendment unit such that the driving force applied to the vehicle wheel is less likely to be reduced during the behavior control. In so doing, the likelihood that the driving force applied to the vehicle wheel will be reduced during the behavior control can be reduced even in a case where the vehicle travels continuously uphill on a rugged slope having a road surface with an extremely low frictional coefficient, for example, such that driving slippage occurs in a vehicle wheel, or more particularly a plurality of vehicle wheels, leading to an increase in the value of the estimated vehicle speed. As a result, a situation in which the driving force applied to the vehicle wheel is reduced unnecessarily during the behavior control while the low speed travel control is underway, leading to a reduction in the vehicle speed and a corresponding reduction in an uphill travel performance of the vehicle, can be prevented from occurring.

In the aspects described above, the determination unit may be configured to determine whether or not the specific condition is established by determining whether or not a travel condition, in which the driving force applied to the vehicle wheel during the low speed travel control is highly likely to be increased at an increase rate equaling or exceeding a predetermined increase rate, is established.

According to this aspect, when a travel condition in which the driving force applied to the vehicle wheel during the low speed travel control is highly likely to be increased at an increase rate equaling or exceeding a predetermined increase rate is determined to be established, the behavior control is amended by the amendment unit such that the driving force applied to the vehicle wheel is less likely to be reduced during the behavior control. In so doing, the likelihood that the driving force applied to the vehicle wheel will be reduced during the behavior control can be reduced even in a case where the driving force applied to the vehicle wheel is increased at a high increase rate such that driving slippage occurs in the vehicle wheel, leading to an increase in the value of the estimated vehicle speed. As a result, a situation in which the driving force applied to the vehicle wheel is reduced unnecessarily during the behavior control while the low speed travel control is underway, leading to a reduction in the vehicle speed and a corresponding reduction in the travel performance of the vehicle in a travel condition where the driving force applied to the vehicle is varied, can be prevented from occurring. Note that this type of travel condition occurs in cases where, for example, the vehicle travels over an obstacle such as a step or a projection on a travel road, the vehicle shifts rapidly from downhill travel to uphill travel, and so on.

In the aspects described above, the determination unit may be configured to determine whether or not the specific condition is established by determining whether or not a reduced responsiveness condition, in which a responsiveness of a brake apparatus that applies a braking force to the vehicle wheel has decreased, is established during execution of the low speed travel control.

According to this aspect, when a reduced responsiveness condition, in which the responsiveness of the brake apparatus that applies the braking force to the vehicle wheel has decreased, is determined to be established during execution of the low speed travel control, the behavior control is amended by the amendment unit such that the driving force applied to the vehicle wheel is less likely to be reduced during the behavior control. In so doing, the likelihood that the driving force applied to the vehicle wheel will be reduced during the behavior control can be reduced even in a case where the responsiveness of the brake apparatus decreases such that an increase in the vehicle wheel speed cannot be suppressed with favorable responsiveness by braking, with the result that the estimated vehicle speed is calculated to a high value. As a result, a situation in which the driving force applied to the vehicle wheel is reduced unnecessarily during the behavior control while the low speed travel control is underway, leading to a reduction in the vehicle speed and a corresponding reduction in the travel performance of the vehicle in a travel condition where the responsiveness of the brake apparatus has decreased, can be prevented from occurring. Note that the reduced responsiveness condition occurs in cases where, for example, knockback occurs in the brake apparatus, the vehicle travels on a bad road, the vehicle travels in an extremely low temperature, and so on.

In the aspects described above, the amendment unit may be configured to amend the behavior control by modifying a method of calculating the estimated vehicle speed such that the estimated vehicle speed is calculated to a smaller value than when the specific condition is determined not to be established.

According to this aspect, the method of calculating the estimated vehicle speed is modified such that the estimated vehicle speed is calculated to a smaller value than when the specific condition is determined not to be established. In so doing, the estimated vehicle speed is less likely to be determined to equal or exceed the permission reference value, and as a result, the likelihood that the driving force applied to the vehicle wheel will be reduced during the behavior control can be reduced.

In the aspects described above, the amendment unit may be configured to amend the behavior control by increasing the permission reference value in comparison with a case where the specific condition is determined not to be established.

According to this aspect, the permission reference value is increased in comparison with a case where the specific condition is determined not to be established. In so doing, the estimated vehicle speed is less likely to be determined to equal or exceed the permission reference value, and as a result, the likelihood that the driving force applied to the vehicle wheel will be reduced during the behavior control can be reduced.

In the aspects described above, the vehicle behavior control apparatus may be configured to calculate an index value indicating instability in the travel behavior of the vehicle, and determine that stabilization of the travel behavior of the vehicle is required when the index value equals or exceeds a determination reference value, and the amendment unit may be configured to amend the behavior control by increasing the determination reference value in comparison with a case where the specific condition is determined not to be established.

According to this aspect, the determination reference value is increased in comparison with a case where the specific condition is determined not to be established. In so doing, the index value indicating instability in the travel behavior of the vehicle is less likely to be determined to equal or exceed the determination reference value, and as a result, the likelihood that the driving force applied to the vehicle wheel will be reduced during the behavior control can be reduced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view showing a configuration of a first embodiment of a travel control apparatus for a vehicle according to the invention, to which a four-wheel-drive vehicle is applied;

FIG. 2 is a flowchart showing an estimated vehicle speed calculation control routine according to the first embodiment;

FIG. 3 is a flowchart showing a behavior control routine according to the first embodiment;

FIG. 4 is a flowchart showing a permission reference value control routine for determining whether or not to permit behavior control in a second embodiment of the travel control apparatus for a vehicle according to the invention;

FIG. 5 is a flowchart showing main parts of a behavior control routine according to the second embodiment;

FIG. 6 is a flowchart showing a reference value control routine for determining whether or not to permit execution of spinning suppression control and drift-out suppression control as behavior control performed in a third embodiment of the travel control apparatus for a vehicle according to the invention;

FIG. 7 is a flowchart showing an estimated vehicle speed calculation control routine performed in a fourth embodiment of the travel control apparatus for a vehicle according to the invention;

FIG. 8 is a flowchart showing a permission reference value control routine for determining whether or not to permit behavior control in a fifth embodiment of the travel control apparatus for a vehicle according to the invention;

FIG. 9 is a flowchart showing a reference value control routine for determining whether or not to permit execution of spinning suppression control and drift-out suppression control as behavior control performed in a sixth embodiment of the travel control apparatus for a vehicle according to the invention;

FIG. 10 is a flowchart showing an estimated vehicle speed calculation control routine performed in a seventh embodiment of the travel control apparatus for a vehicle according to the invention;

FIG. 11 is a flowchart showing a permission reference value control routine for determining whether or not to permit behavior control in an eighth embodiment of the travel control apparatus for a vehicle according to the invention;

FIG. 12 is a flowchart showing a reference value control routine for determining whether or not to permit execution of spinning suppression control and drift-out suppression control as behavior control performed in a ninth embodiment of the travel control apparatus for a vehicle according to the invention;

FIG. 13 is a graph showing examples of vehicle wheel speeds Vwfr, Vwfl, Vwrr, and Vwrl of respective vehicle wheels, an actual vehicle speed Vp, and an estimated vehicle speed Va obtained by a related art;

FIG. 14 is a graph showing examples of the vehicle wheel speeds Vwfr, Vwfl, Vwrr, and Vwrl of the respective vehicle wheels, the actual vehicle speed Vp, and the estimated vehicle speed Va obtained by the travel control apparatus according to the first embodiment; and

FIG. 15 is a graph showing examples of the vehicle wheel speeds Vwfr, Vwfl, Vwrr, and Vwrl of the respective vehicle wheels, the actual vehicle speed Vp, and the estimated vehicle speed Va obtained by the travel control apparatus according to the second embodiment.

### DETAILED DESCRIPTION OF EMBODIMENTS

Preferred embodiments will be described in detail below with reference to the attached drawings.

### First Embodiment

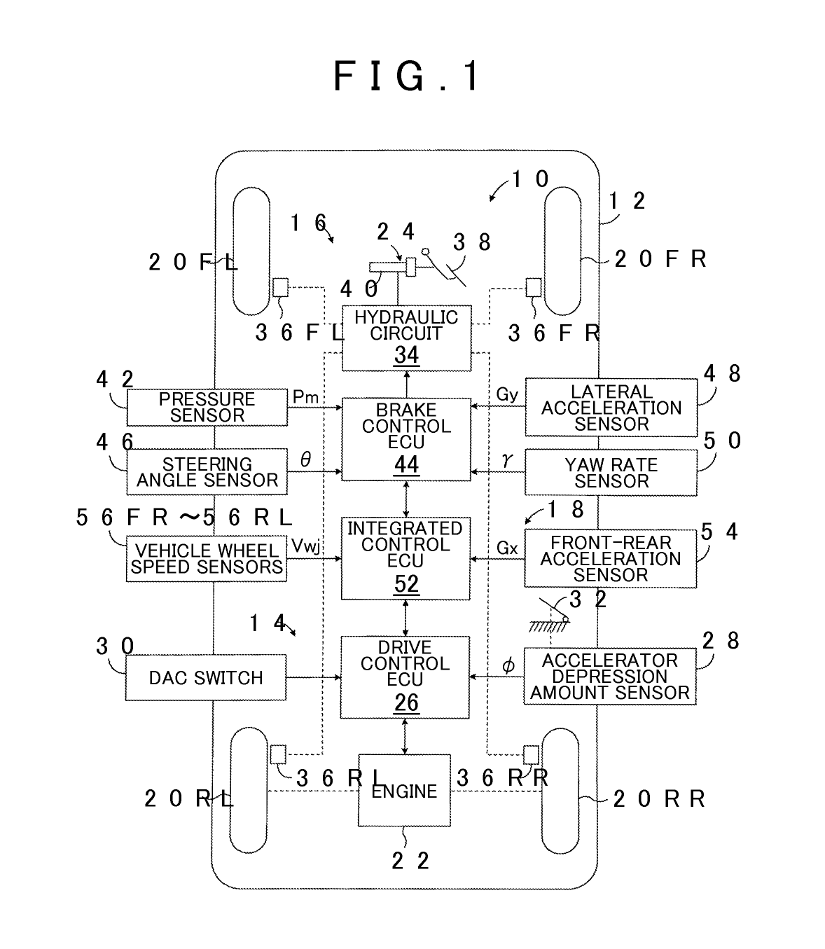

FIG. 1 is a schematic view showing a configuration of a first embodiment of a travel control apparatus 10 for a vehicle according to the invention, to which a four-wheel-drive vehicle is applied. The travel control apparatus 10 is installed in a vehicle 12, and includes a low speed travel apparatus 14, a vehicle behavior control apparatus 16, and an integrated control apparatus 18. The low speed travel apparatus 14 performs low speed travel control to cause the vehicle 12 to travel at a low speed without the need for a driver to perform a driving operation. The vehicle behavior control apparatus 16 performs vehicle behavior control using an estimated vehicle speed calculated on the basis of a vehicle wheel speed. The integrated control apparatus 18 controls the low speed travel apparatus 14 and the vehicle behavior control apparatus 16 in an integrated fashion as required.

The vehicle 12 includes a right front wheel 20FR, a left front wheel 20FL, a right rear wheel 20RR, and a left rear wheel 20RL. The right front wheel 20FR and the left front wheel 20FL serve as steered wheels that are steered via a right tie rod and a left tie rod, respectively, by a steering apparatus, not shown in FIG. 1, which is driven in response to a steering operation performed on a steering wheel by the driver.

The vehicle 12 also includes an engine 22 serving as a drive source, and a brake apparatus 24 that generates a braking force. A driving force of the engine 22 is transmitted to the front wheels 20FR, 20FL and the rear wheels 20RR, 20RL via a driving force transmission system including a speed change apparatus, a center differential gear apparatus, front wheel and rear wheel differential gear apparatuses, and so on, none of which are shown in FIG. 1. Note that the drive source may be a hybrid system or an electric motor.

The low speed travel apparatus 14 includes a drive control electronic control unit 26, an accelerator depression amount sensor 28, and a low speed travel (DAC) switch 30 (hereafter, “electronic control unit” will be abbreviated to ECU). The accelerator depression amount sensor 28 detects a depression amount of an accelerator pedal 32 depressed by the driver as an accelerator depression amount φ. The low speed travel switch 30 is switched ON and OFF by operations performed by a vehicle passenger.

The drive control ECU 26 controls an output of the engine 22 in accordance with the accelerator depression amount φ normally, and controls the output of the engine 22 irrespective of driving operations performed by the driver as required. In particular, when the low speed travel switch 30 is ON, the drive control ECU 26 performs low speed travel control to cause the vehicle 12 to travel at a low speed of approximately several km/hour, as described in JP 2004-90679 A, for example. During the low speed travel control, driving forces and/or braking forces applied to the respective vehicle wheels are controlled to maintain the estimated vehicle speed (described in detail below) within a predetermined low vehicle speed range.

The brake apparatus 24 includes a hydraulic circuit 34, wheel cylinders 36FR, 36FL, 36RR, and 36RL provided to correspond respectively to the right front wheel, the left front wheel, the right rear wheel, and the left rear wheel, a brake pedal 38, and a master cylinder 40. Although not shown in FIG. 1, the hydraulic circuit 34 includes an oil reservoir, an oil pump, various valve apparatuses, and so on. The braking forces applied to the respective vehicle wheels are controlled by controlling internal pressures Pj (j=fr, fl, rr, and rl) of the wheel cylinders 36FR, 36FL, 36RR, and 36RL, or in other words braking pressures, using the hydraulic circuit 34. Note that fr, fl, rr, and rl respectively denote the right front wheel, the left front wheel, the right rear wheel, and the left rear wheel.

An internal pressure of the master cylinder 40, which is driven in response to an operation performed by the driver to depress the brake pedal 38, or in other words a master cylinder pressure Pm, is detected by a pressure sensor 42. The braking pressures of the respective wheel cylinders are controlled in accordance with the master cylinder pressure Pm normally, and controlled individually by having a brake control ECU 44 control the hydraulic circuit 34 as required. Hence, the brake apparatus 24 is capable of controlling the braking forces applied to the respective vehicle wheels irrespective of a braking operation performed by the driver.

Note that when braking slippage in one of the vehicle wheels becomes excessive, the brake control ECU 44 performs antiskid control (ABS control) to reduce the braking slippage by reducing the braking force applied to the corresponding vehicle wheel. Further, when it is determined from a depression speed and a depression force of the brake pedal that emergency braking is underway, the brake control ECU 44 performs brake assist control (BA control) to generate a large braking force by increasing the braking pressure.

The vehicle behavior control apparatus 16 includes the brake apparatus 24, the brake control ECU 44, a steering angle sensor 46, a lateral acceleration sensor 48, and a yaw rate sensor 50. The steering angle sensor 46 detects a steering angle θ, i.e. a steering operation amount generated by the driver. The lateral acceleration sensor 48 detects a lateral acceleration Gy of the vehicle. The yaw rate sensor 50 detects a yaw rate γ of the vehicle.

The integrated control apparatus 18 includes an integrated control ECU 52, a front-rear acceleration sensor 54, and vehicle wheel speed sensors 56FR, 56FL, 56RR, and 56RL provided respectively on the right front wheel, the left front wheel, the right rear wheel, and the left rear wheel. The front-rear acceleration sensor 54 detects a front-rear acceleration Gx of the vehicle. The vehicle wheel speed sensors 56FR to 56RL respectively detect vehicle wheel speeds Vwj (j=fr, fl, rr, rl) of the right front wheel, the left front wheel, the right rear wheel, and the left rear wheel. The integrated control ECU 52 exchanges signals with the drive control ECU 26 and the brake control ECU 44 as required.

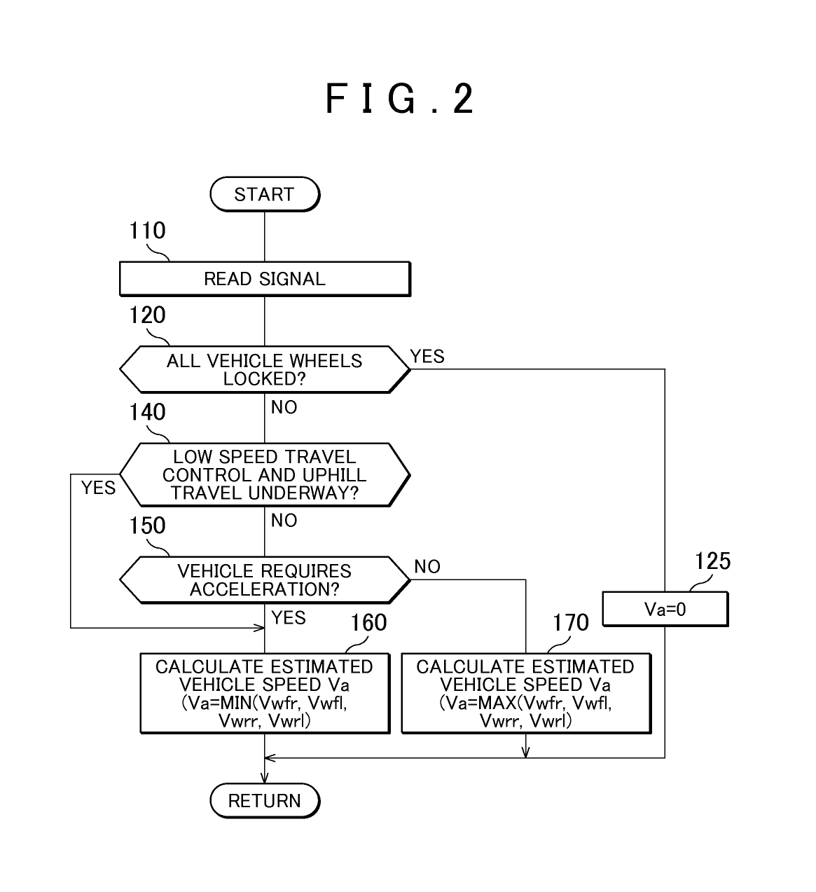

The integrated control ECU 52 of the integrated control apparatus 18 calculates an estimated vehicle speed Va to be used in the vehicle behavior control executed by the vehicle behavior control apparatus 16 on the basis of the vehicle wheel speeds Vwj in accordance with a flowchart shown in FIG. 2. In the first embodiment in particular, as will be described in detail below, when “the low speed travel control is underway and the vehicle 12 is traveling on an uphill road”, the integrated control ECU 52 calculates the estimated vehicle speed Va such that control of the braking and driving forces applied to the vehicle wheels is restricted during the behavior control.

More specifically, in cases other than when “the low speed travel control is underway and the vehicle 12 is traveling on an uphill road”, the integrated control ECU 52 sets a maximum value of the vehicle wheel speeds Vwj of the four wheels as the estimated vehicle speed Va. The reason for selecting the maximum value is that this value is the vehicle wheel speed that is least affected by braking and so on. Conversely, when “the low speed travel control is underway and the vehicle 12 is traveling on an uphill road”, the integrated control ECU 52 sets a minimum value of the vehicle wheel speeds Vwj of the four wheels as the estimated vehicle speed Va.

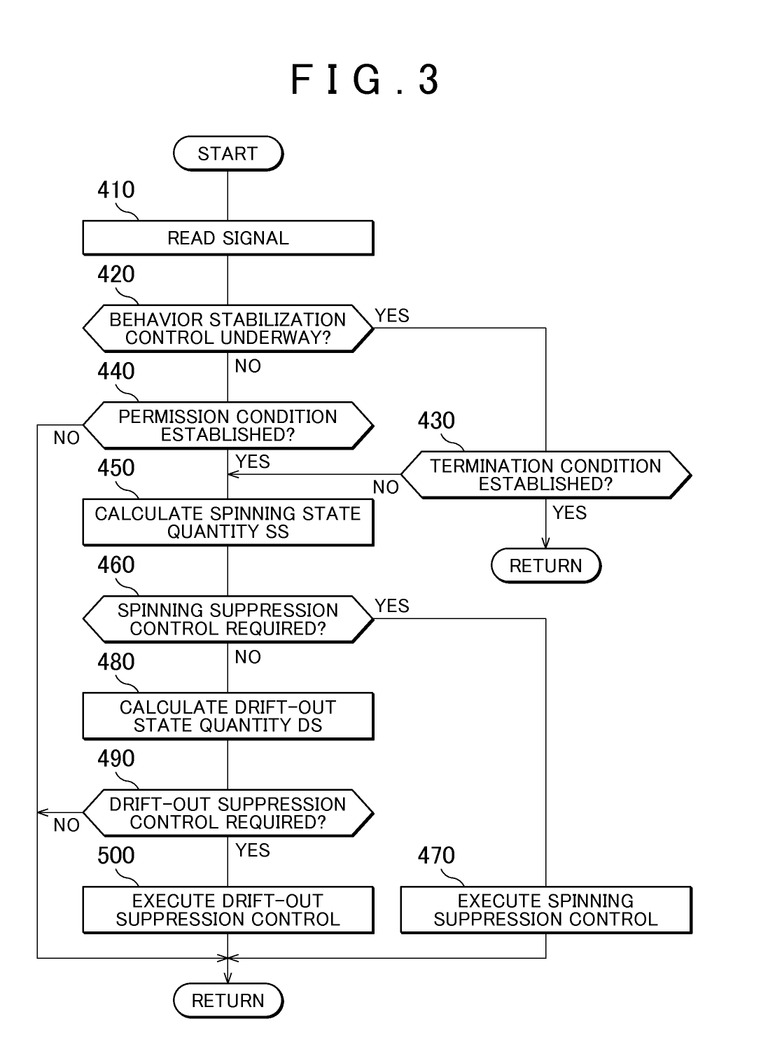

The brake control ECU 44 of the vehicle behavior control apparatus 16, as well as controlling the braking forces applied to the vehicle wheels in the manner described above, performs behavior control to stabilize travel behavior of the vehicle in accordance with a flowchart shown in FIG. 3. More particularly, as will be described in detail below, the brake control ECU 44 determines whether or not to reduce the driving forces applied to the vehicle wheels for the purpose of the behavior control by determining whether or not the estimated vehicle speed Va equals or exceeds a permission reference value Vth. Further, the brake control ECU 44 uses the estimated vehicle speed Va to calculate an index value indicating instability in the vehicle travel behavior. Furthermore, having determined on the basis of the index value that the behavior of the vehicle needs to be stabilized, the brake control ECU 44 stabilizes the vehicle travel behavior by applying a braking force to a predetermined vehicle wheel and/or reducing the vehicle driving force in order to reduce the driving force of the predetermined vehicle wheel.

When the estimated vehicle speed Va is set at the minimum value of the vehicle wheel speeds Vwj of the four wheels, the estimated vehicle speed Va is less likely to be determined to equal or exceed the permission reference value Vth. Therefore, the integrated control apparatus 18 functions as amending means for amending the behavior control so that the braking forces applied to the vehicle wheels are less likely to be reduced during the behavior control. Furthermore, as will be described in detail below, the integrated control apparatus 18 functions as uphill road travel condition determining means for determining whether or not the vehicle is traveling on an uphill road.

Note that the drive control ECU 26, the brake control ECU 44, and the integrated control ECU 52 may be constituted respectively by microcomputers that each include a central processing unit (CPU), a read only memory (ROM), a random access memory (RAM), and an input/output port apparatus and are connected to each other by a bidirectional common bus. Further, the respective sensors and the low speed travel switch 30 may be connected to any of the ECUs, and outputs of the respective sensors and information indicating a set position of the low speed travel switch 30 may be transmitted via a controller area network (CAN), for example, which connects the ECUs to each other.

### Estimated Vehicle Speed Calculation Control

(FIG. 2) Next, referring to the flowchart shown in FIG. 2, an estimated vehicle speed calculation control routine according to the first embodiment will be described. Control illustrated in the flowchart of FIG. 2 is executed repeatedly at predetermined time intervals by the integrated control ECU 52 of the integrated control apparatus 18 when an ignition switch, not shown in the drawings, is switched ON. Note that in the following description of FIG. 2, the estimated vehicle speed calculation control illustrated in the flowchart of FIG. 2 will be referred to simply as the “control”.

First, in step 110, a signal or the like indicating the vehicle wheel speeds Vwj is read. Next, in step 120, a determination is made as to whether or not all of the vehicle wheels are locked by determining whether or not a braking slippage rate of all of the vehicle wheels, for example, is in a locked condition. When the determination is negative, the control advances to step 140, and when the determination is affirmative, the estimated vehicle speed Va is set at 0 in step 125.

In step 140, a determination is made as to “whether or not a specific condition in which the estimated vehicle speed Va calculated during execution of the low speed travel control is highly likely to equal or exceed the permission reference value Vth is established” by determining whether or not “the low speed travel control is underway and the vehicle 12 is traveling on an uphill road”. When the determination is affirmative, the control advances to step 160, and when the determination is negative, the control advances to step 150. Hence, a function of determining means for determining whether or not the estimated vehicle speed Va may possibly be calculated to a value equaling or exceeding the permission reference value Vth due to driving slippage occurring in a vehicle wheel while the vehicle 12 travels on an uphill road in a condition where the low speed travel is underway is realized by step 140.

Note that the determination as to whether or not the vehicle 12 is traveling on an uphill road may be made as desired. For example, a target acceleration Gxt of the vehicle may be calculated on the basis of the output of the engine 22 and a gear ratio of the speed change apparatus, not shown in FIG. 1, and the vehicle may be determined to be traveling on uphill road when a difference (Gxt−Gt) between the target acceleration Gxt and the front-rear acceleration Gx of the vehicle remains at or above a reference value Gxc (a positive integer) continuously for at least a predetermined time. Further, an incline sensor that detects an incline of the travel road in a front-rear direction of the vehicle may be provided, and the vehicle may be determined to be traveling on an uphill road when a detection value from the incline sensor remains at or above a reference value continuously for at least a predetermined time.

In step 150, a determination is made as to whether or not the vehicle 12 is in a condition requiring acceleration (including being maintained at a constant speed). When the determination is negative, the control advances to step 170, and when the determination is affirmative, the control advances to step 160.

Note that the vehicle 12 may be determined to be in a condition requiring acceleration when all of following conditions a1 to a5 are satisfied. a1. The accelerator depression amount φ is larger than 0. a2. The behavior control is not underway. a3. The antiskid control is not underway. a4. The brake assist control is not underway. a5. The brake pedal 38 is not depressed. a6. Trailer sway control is not underway.

Further, when trailer sway control is performed as required in the case of a coupled vehicle in which two vehicles, such as a mutually coupled tractor and trailer, are coupled to each other in the front-rear direction, for example, the vehicle 12 may be determined to be in a condition requiring acceleration when all of the above conditions a1 to a6 are satisfied. Note that trailer sway control, as described in Japanese Patent Application Publication No. 10-236289 (JP 10-236289 A), for example, is control for suppressing a sway phenomenon by applying a brake to left and right wheels of a rear side vehicle (a trailer) when a hitch angle equals or exceeds a reference value due to the sway phenomenon.

In step 160, the estimated vehicle speed Va to be used in the vehicle behavior control is calculated in accordance with Equation (1), shown below. Note that MIN ( ) in Equation (1) indicates a minimum value of the value in parentheses. In other words, the minimum value of the value in parentheses is set as the estimated vehicle speed Va.

Va=MIN (Vwfr, Vwfl, Vwrr, Vwrl) (1)

In step 170, the estimated vehicle speed Va to be used in the vehicle behavior control is calculated in accordance with Equation (2), shown below. Note that MAX ( ) in Equation (2) indicates a maximum value of the value in parentheses. In other words, the maximum value of the value in parentheses is set as the estimated vehicle speed Va.

Va=MAX (Vwfr, Vwfl, Vwrr, Vwrl) (2)

### Behavior Control

(FIG. 3) Next, referring to the flowchart shown in FIG. 3, a behavior control routine according to the first embodiment will be described. Control illustrated in the flowchart of FIG. 3 is executed repeatedly at predetermined time intervals by the brake control ECU 44 of the vehicle behavior control apparatus 16 when the ignition switch, not shown in the drawings, is switched ON. Note that in the following description of FIG. 3, the behavior control illustrated in the flowchart of FIG. 3 will be referred to simply as the “control”.

First, in step 410, a signal or the like indicating the estimated vehicle speed Va calculated by the integrated control ECU 52 of the integrated control apparatus 18 is read. Next, in step 420, a determination is made as to whether or not the driving forces applied to the vehicle wheels have been reduced in the vehicle behavior control. When the determination is negative, the control advances to step 440, and when the determination is affirmative, the control advances to step 430.

In step 430, a determination is made as to whether or not a vehicle behavior control termination condition is established. When the determination is negative, the control advances to step 450, and when the determination is affirmative, the control is temporarily terminated. Note that the behavior control termination condition may be determined to be established when all of following conditions b1 to b4 are satisfied. b1. When the behavior control is spinning suppression control, a spinning state quantity SS to be described below is equal to or smaller than a control termination reference value SSe (a positive integer). b2. When the behavior control is drift-out suppression control, a drift-out state quantity DS to be described below is equal to or smaller than a control termination reference value DSe (a positive integer). b3. An irregularity has occurred in a sensor or the brake apparatus 24 so that the behavior control can no longer be executed normally. b4. The estimated vehicle speed Va is lower than the permission reference value Vth (a positive integer) of the behavior control.

In step 440, a determination is made as to whether or not a vehicle behavior control permission condition is established. When the determination is negative, the control is temporarily terminated, and when the determination is affirmative, the control advances to step 450. In this case, the behavior control permission condition may be determined to be established when both c1. the respective sensors and the brake apparatus 24 are normal so that the behavior control can be executed normally, and c2. the estimated vehicle speed Va equals or exceeds the permission reference value Vth.

In step 450, the spinning state quantity SS is calculated as an index value indicating instability in the vehicle travel behavior. Note that the spinning state quantity SS is a value indicating a degree of spinning in the vehicle, and may be calculated as desired as long as it is calculated using the estimated vehicle speed Va.

For example, a lateral acceleration deviation, or in other words a sideslip acceleration Vyd of the vehicle, is calculated as a deviation Gy−Va×γ between the lateral acceleration Gy of the vehicle and a product Va×γ of the estimated vehicle speed Va and the yaw rate γ. Further, a sideslip speed Vy of a vehicle body is calculated by integrating the sideslip acceleration Vyd, whereupon a slippage angle β of the vehicle body is calculated as a ratio Vy/Vx of the sideslip speed Vy of the vehicle body relative to a front-rear speed Vx (=the estimated vehicle speed Va) of the vehicle body.

Further, a spinning amount SV is calculated as a linear sum K1×β+K2×Vyd of the slippage angle β and the sideslip acceleration Vyd of the vehicle body, where K1 and K2 are respectively positive integers, and a turning direction of the vehicle is determined on the basis of a symbol of the yaw rate γ. The spinning state quantity SS is calculated as SV when the vehicle turns left and as −SV when the vehicle turns right, and when the calculated value of SS or −SV is negative, the spinning state quantity is set at 0. The spinning amount SV may be calculated as a linear sum of the slippage angle β of the vehicle body and a differential value βd thereof.

In step 460, a determination is made as to whether or not the spinning state quantity SS equals or exceeds a determination reference value SSs (a positive integer) for determining whether or not to permit execution of the spinning suppression control, or in other words whether or not the spinning suppression control is required. When the determination is negative, the control advances to step 480, and when the determination is affirmative, the control advances to step 470.

In step 470, the spinning suppression control is executed to reduce the degree of spinning in the vehicle by reducing the driving force applied to a predetermined vehicle wheel so as to reduce the yaw rate of the vehicle and decelerate the vehicle. Note that the spinning suppression control is not a constituent element of the invention, and may therefore be executed as desired. For example, a target braking slippage rate Sfoutt of a turn outer side front wheel is calculated to increase steadily as the spinning state quantity SS increases, and the braking pressure applied to the turn outer side front wheel is controlled in an increasing direction so that the braking slippage rate of the turn outer side front wheel reaches the target braking slippage rate Sfoutt. As a result, the driving force applied to the turn outer side front wheel decreases.

In step 480, the drift-out state quantity DS is calculated as another index value indicating instability in the vehicle travel behavior. Note that the drift-out state quantity DS is a value indicating a degree of drift-out in the vehicle, and may be calculated as desired as long as it is calculated using the estimated vehicle speed Va.

For example, a target yaw rate γc is calculated in accordance with Equation (3), shown below, using Kh as a stability factor, H as a wheelbase, and Rg as a steering gear ratio, and a reference yaw rate γt is calculated in accordance with Equation (4), shown below, using T as a time constant and s as a Laplacian operator. Note that in order to obtain a dynamic yaw rate, the target yaw rate γc may be calculated taking the lateral acceleration Gy of the vehicle into account.

γc=Va×(θ/Rg)/{(1+Kh×Va²)×H} (3)

γt=γc/(1+T×s) (4)

A drift-out amount DV is then calculated in accordance with Equation (5), shown below, whereupon the turning direction of the vehicle is determined on the basis of the symbol of the yaw rate γ. Further, the drift-out state quantity DS is calculated as DV when the vehicle turns left and as −DV when the vehicle turns right, and when the calculated value of DS or −DV is negative, the drift-out state quantity is set at 0. Note that the drift-out amount DV may be calculated in accordance with Equation (6), shown below.

DV=(γt−γ) (5)

DV=H×(γt−γ)/V (6)

In step 490, a determination is made as to whether or not the drift-out state quantity DS equals or exceeds a determination reference value DSs (a positive integer) for determining whether or not to permit execution of the drift-out suppression control, or in other words whether or not the drift-out suppression control is required. When the determination is negative, the control is temporarily terminated, and when the determination is affirmative, the control advances to step 500.

In step 500, the drift out suppression control is executed to reduce the degree of drift-out in the vehicle by reducing the driving force applied to a predetermined vehicle wheel so that a yaw moment for reducing the yaw rate of the vehicle is applied to the vehicle and the vehicle is decelerated. Note that the drift-out suppression control is not a constituent element of the invention, and may therefore be executed as desired. For example, respective target braking slippage rates Sroutt, Srint of a turn outer side rear wheel and a turn inner side rear wheel are calculated to increase steadily as the drift-out state quantity DS increases. The respective braking pressures of the turn outer side rear wheel and the turn inner side rear wheel are then controlled in an increasing direction so that the braking slippage rates thereof respectively reach the target braking slippage rates Sroutt, Srint. As a result, the driving forces applied to the turn outer side rear wheel and the turn inner side rear wheel decrease.

As is evident from the above description, a determination as to whether or not “the low speed travel control is underway and the vehicle 12 is traveling on an uphill road” is made as the determination of step 140 as to whether or not “a specific condition is established”. More specifically, a determination is made as to whether or not “a specific condition in which the estimated vehicle speed Va is highly likely to equal or exceed the permission reference value Vth during execution of the low speed travel control even though the actual vehicle speed V is lower than the permission reference value Vth is established”. When the determination of step 140 is affirmative, the estimated vehicle speed Va to be used in the behavior control is set at the minimum value of the vehicle wheel speeds Vwj of the four wheels in step 160. As a result, the estimated vehicle speed Va takes a smaller value than the value thereof in the case of a related art, in which the estimated vehicle speed is set at the maximum value of the vehicle wheel speeds Vwj of the four wheels. The estimated vehicle speed Va is also set at a smaller value than the value thereof in a case where the condition “the low speed travel control is underway and the vehicle 12 is traveling on an uphill road” is determined not to be established in step 140, and the vehicle 12 is determined not to be in a condition requiring acceleration in step 150.

Hence, in step 440, the estimated vehicle speed Va is unlikely to be determined to equal or exceed the permission reference value Vth, and therefore the steps from step 450 onwards are unlikely to be executed. In other words, the spinning suppression control and the drift-out suppression control are unlikely to be executed. Accordingly, the driving forces applied to the vehicle wheels are less likely to be reduced during the behavior control, and as a result, a risk that the driving forces applied to the vehicle wheels will be reduced unnecessarily while the low speed travel control is underway, leading to a reduction in the vehicle speed and a corresponding reduction in an uphill travel performance of the vehicle, can be reduced.

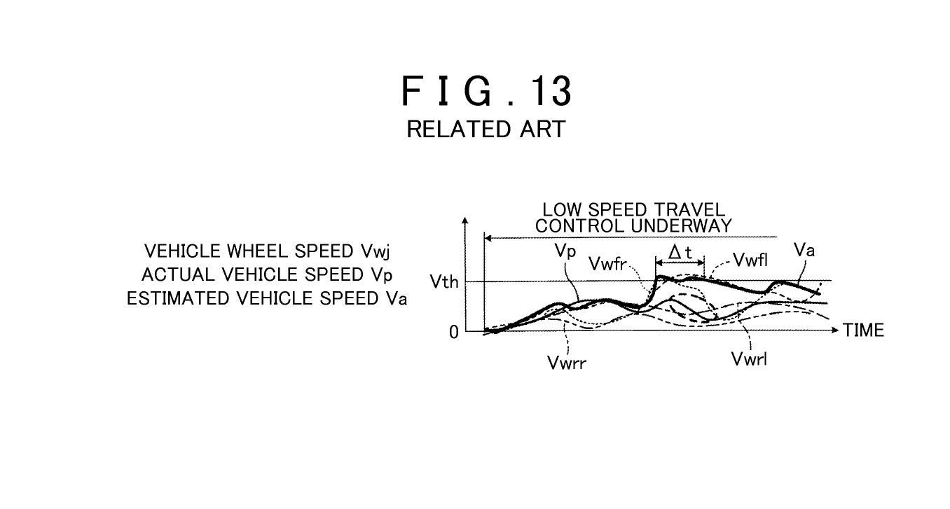

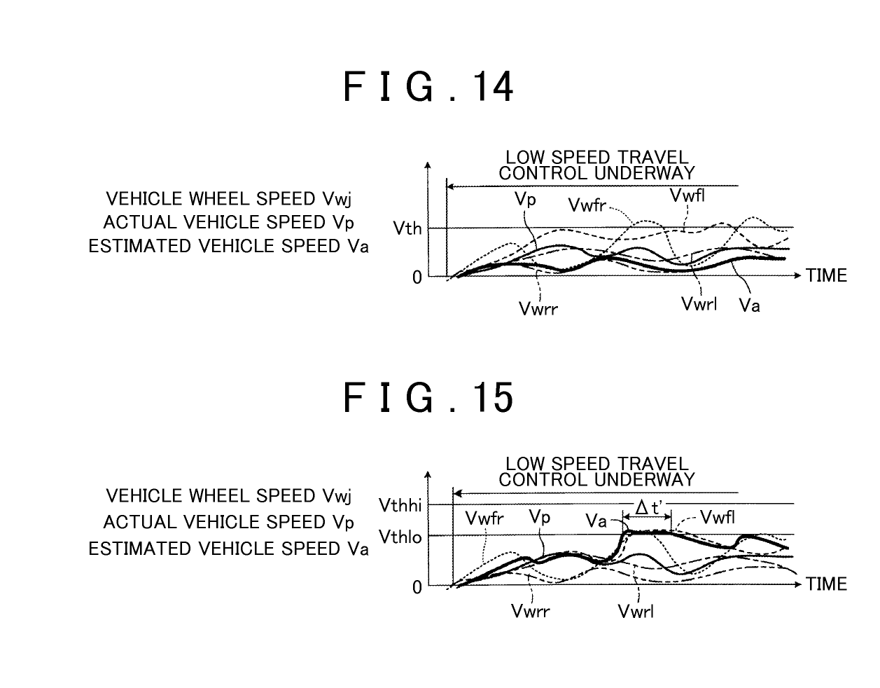

For example, FIGS. 13 and 14 show examples of variation in the respective vehicle wheel speeds Vwfr, Vwfl, Vwrr, and Vwrl of the right front wheel, the left front wheel, the right rear wheel, and the left rear wheel, wherein a thin solid line shows the actual vehicle speed Vp. In particular, a thick solid line in FIG. 13 shows the estimated vehicle speed Va in a related art, and a thick solid line in FIG. 14 shows the estimated vehicle speed Va in the travel control apparatus according to the first embodiment.

Note that the reason why the estimated vehicle speed Va does not match the maximum value of the vehicle wheel speeds Vwj of the four wheels in FIG. 13 and the estimated vehicle speed Va does not match the minimum value of the vehicle wheel speeds Vwj of the four wheels in FIG. 14 is that variation in the estimated vehicle speed Va has been suppressed by guard processing.

In the example shown in FIG. 13, the actual vehicle speed Vp is lower than the permission reference value Vth, but in a section Δt, the estimated vehicle speed Va equals or exceeds the permission reference value Vth, and therefore the determination of step 440 becomes affirmative such that the driving forces applied to the vehicle wheels are reduced unnecessarily during the behavior control. As a result, the driving force of the vehicle decreases such that the vehicle decelerates unnecessarily, as shown by a region surrounded by a thick dotted line in FIG. 13.

According to the first embodiment, on the other hand, the estimated vehicle speed Va remains lower than the permission reference value Vth even when the maximum value of the vehicle wheel speeds Vwj of the four wheels equals or exceeds the permission reference value Vth, and therefore the determination of step 440 does not become affirmative. Accordingly, the driving forces applied to the vehicle wheels are not reduced unnecessarily during the behavior control, and as a result, the vehicle does not decelerate unnecessarily.

### Second Embodiment

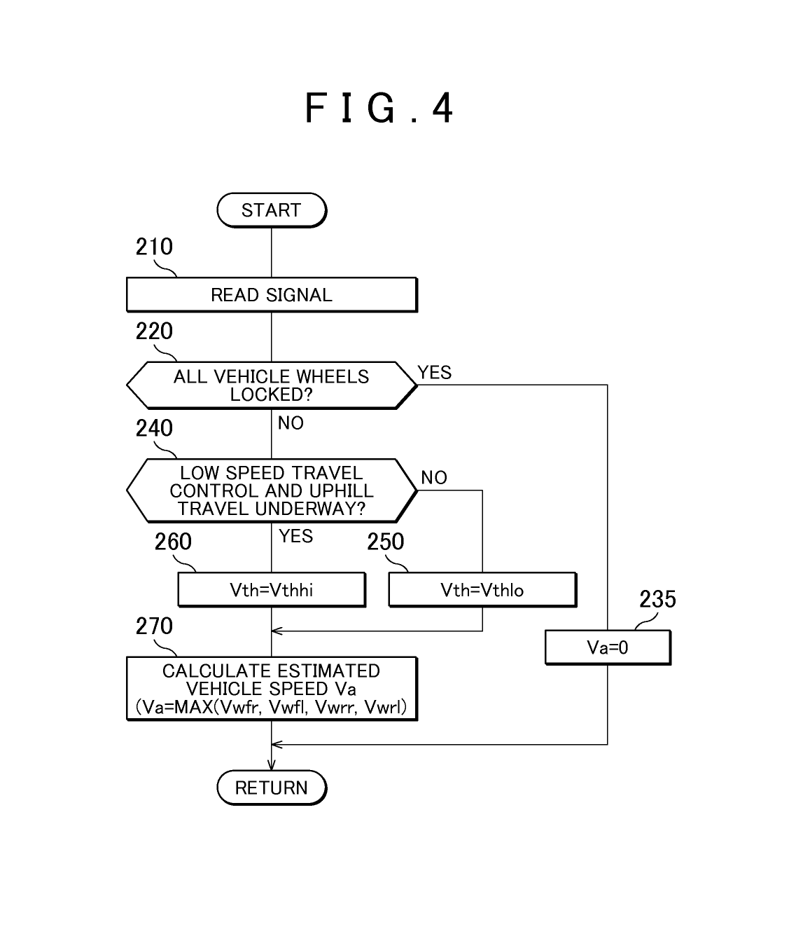

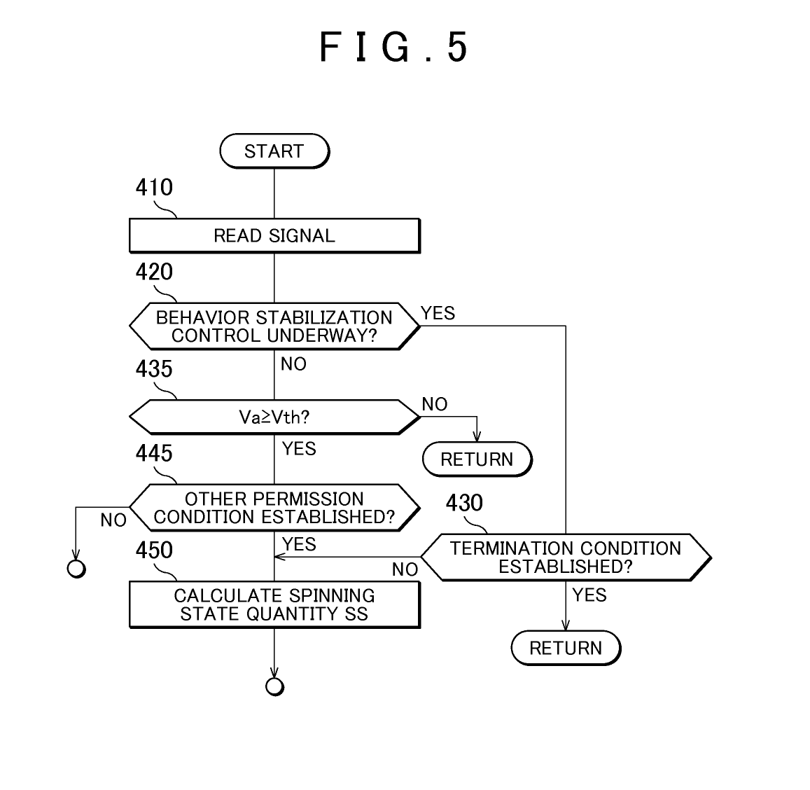

FIG. 4 is a flowchart showing a vehicle speed permission reference value control routine for determining whether or not to permit behavior control in a second embodiment of the travel control apparatus for a vehicle according to the invention, and FIG. 5 is a flowchart showing main parts of a behavior control routine according to the second embodiment.

Steps 210 to 240 of the routine shown in FIG. 4 are executed respectively in a similar manner to steps 110 to 140 of the first embodiment, and step 270 is executed in a similar manner to step 170 of the first embodiment.

Note, however, that when a negative determination is made in step 220, the control advances to step 240, where a similar determination to step 140 is performed. When the determination of step 240 is negative, the vehicle speed permission reference value Vth for determining whether or not to permit the behavior control is set at a standard value Vthlo (a positive integer) in step 250. When the determination of step 240 is affirmative, on the other hand, the vehicle speed permission reference value Vth is set at Vthhi (a larger positive integer than the standard value Vthlo) in step 260.

When step 250 or step 260 is complete, the control advances to step 270, and when step 235 or step 270 is complete, the control is temporarily terminated.

Further, although FIG. 5 shows only the main parts of the behavior control routine according to the second embodiment, the behavior control routine according to this embodiment differs from the routine shown in FIG. 3 only in that step 440 in FIG. 3 is replaced by steps 435 and 445. Hence, steps of this embodiment other than steps 435 and 445 are executed in a similar manner to the respectively corresponding steps of the first embodiment. Note, however, that in step 410, a signal indicating the vehicle speed permission reference value Vth set in step 250 or 260 is also input.

As shown in FIG. 5, when the determination of step 420 is negative, steps 435 and 445 are executed prior to step 450. In step 435, a determination is made as to whether or not the estimated vehicle speed Va equals or exceeds the vehicle speed permission reference value Vth calculated in step 250 or 260, or in other words whether or not the estimated vehicle speed Va is a vehicle speed at which to permit execution of the behavior control. When the determination is negative, the control is temporarily terminated without controlling the braking forces for the purpose of behavior stabilization. When the determination is affirmative, the control advances to step 445.

In step 445, a determination is made as to whether or not another condition for permitting the behavior control is established. More specifically, a determination is made as to whether or not the respective sensors and the brake apparatus 24 are normal so that the behavior control can be executed normally. When the determination is negative, the control is temporarily terminated without controlling the braking forces for the purpose of behavior stabilization. When the determination is affirmative, the control advances to step 450, whereupon steps 450 to 500 are executed in a similar manner to the first embodiment.

As is evident from the above description, a determination as to whether or not “the low speed travel control is underway and the vehicle 12 is traveling on an uphill road”, or in other words whether or not “a specific condition is established”, is made in step 240. When the determination of step 240 is affirmative, the vehicle speed permission reference value Vth is set at Vthhi, which is larger than the standard value Vthlo, in step 260. As a result, the determination of step 435 is more likely to be negative than when the vehicle speed permission reference value Vth is set at the standard value Vthlo.

Hence, by increasing the vehicle speed permission reference value Vth, execution of steps 450 to 500 can be suppressed such that the driving forces applied to the vehicle wheels are less likely to be reduced unnecessarily during the behavior control. As a result, the risk that the driving forces applied to the vehicle wheels will be reduced unnecessarily while the low speed travel control is underway, leading to a reduction in the vehicle speed and a corresponding reduction in the uphill travel performance of the vehicle, can be reduced.

For example, FIG. 15, similarly to FIG. 13, shows the vehicle wheel speeds Vwj of the respective vehicle wheels, the actual vehicle speed Vp (a thin solid line), and the estimated vehicle speed Va (a thick solid line). According to the second embodiment, as shown in FIG. 15, when it is determined that the vehicle 12 is traveling uphill and the low speed travel control is underway, the vehicle speed permission reference value Vth is set at Vthhi, which is larger than the standard value Vthlo, in step 260. In so doing, the estimated vehicle speed Va is prevented from equaling or exceeding the vehicle speed permission reference value Vth, and therefore the driving forces applied to the vehicle wheels are not reduced unnecessarily during the behavior control even in a section Δt′ in FIG. 15, which corresponds to the section Δt in FIG. 13.

### Third Embodiment

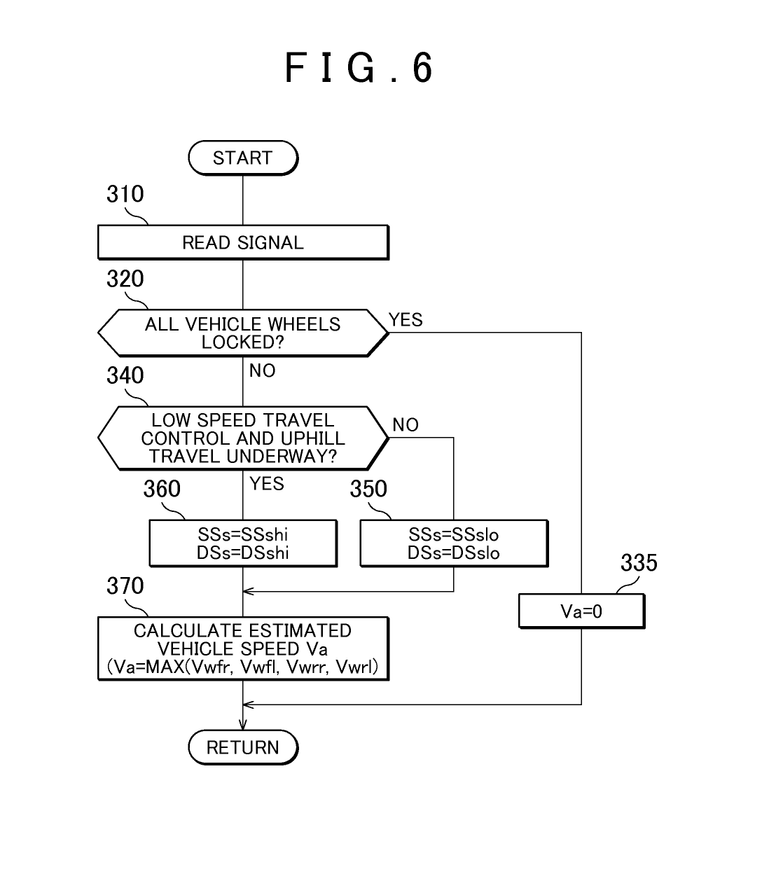

FIG. 6 is a flowchart showing a reference value control routine for determining whether or not to permit execution of spinning suppression control and drift-out suppression control as behavior control performed in a third embodiment of the travel control apparatus for a vehicle according to the invention.

Steps 310 to 340 of the reference value control routine according to the third embodiment are executed respectively in a similar manner to steps 110 to 140 (FIG. 2) of the first embodiment, and step 370 is executed in a similar manner to step 170 (FIG. 2) of the first embodiment.

Note, however, that when the determination of step 320 is negative, the control advances to step 335, which corresponds to step 125. When a negative determination is made in step 340, the reference value SSs for determining whether or not to permit execution of the spinning suppression control and the reference value DSs for determining whether or not to permit execution of the drift-out suppression control are set respectively at standard values SSslo (a positive integer) and DSslo (a positive integer) in step 350. When the determination of step 340 is affirmative, on the other hand, the reference values SSs and DSs are set respectively at SSshi (a larger positive integer than the standard value SSslo) and DSshi (a larger positive integer than the standard value DSslo) in step 360.

When step 350 or step 360 is complete, the control advances to step 370, and when step 335 or step 370 is complete, the control is temporarily terminated.

Further, although a behavior control routine according to the third embodiment is not shown, respective steps of the behavior control routine are executed in a similar manner to the corresponding steps of the first embodiment, shown in FIG. 3.

Note, however, that in step 410, signals indicating the reference values SSs and DSs set in step 350 or 360 are also input. Further, the reference values SSs and DSs read in step 410 are used to determine in step 460 whether or not the spinning suppression control is required and to determine in step 490 whether or not the drift-out suppression control is required.

As is evident from the above description, a determination as to whether or not “the low speed travel control is underway and the vehicle 12 is traveling on an uphill road”, or in other words whether or not “a specific condition is established”, is made in step 340. When the determination of step 340 is affirmative, the reference values SSs and DSs are set respectively at SSshi and DSshi, which are larger than the standard values SSslo and DSslo, in step 360. As a result, the determinations of steps 460 and 490 are more likely to be negative than when the reference values SSs and DSs are set respectively at the standard values SSslo and DSslo.

Hence, when the reference values SSs and DSs are increased, steps 470 and 500 are less likely to be executed, and therefore the driving forces applied to the vehicle wheels are less likely to be reduced during the behavior control. As a result, the risk that the driving forces applied to the vehicle wheels will be reduced unnecessarily while the low speed travel control is underway, leading to a reduction in the vehicle speed and a corresponding reduction in the uphill travel performance of the vehicle, can be reduced.

### Fourth Embodiment

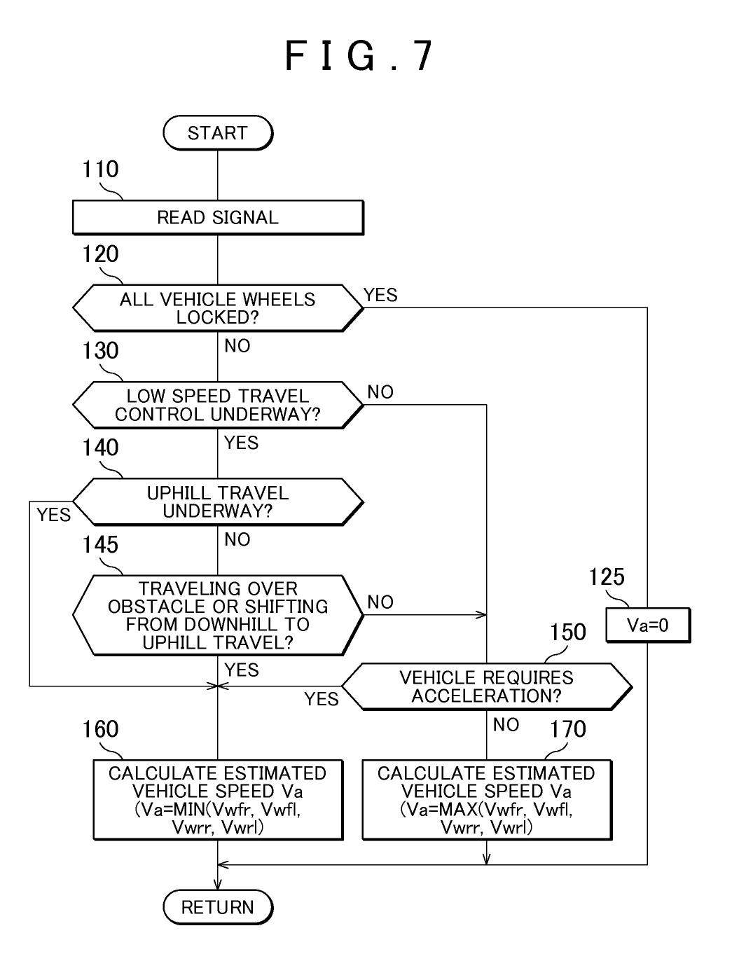

FIG. 7 is a flowchart showing an estimated vehicle speed calculation control routine performed in a fourth embodiment of the travel control apparatus for a vehicle according to the invention.

Steps 110, 120, 125, and 150 to 170 of the routine shown in FIG. 7 are executed in a similar manner to the respectively corresponding steps of the first embodiment. Note, however, that when a negative determination is made in step 120, the control advances to step 130.

In step 130, a determination is made as to whether or not the low speed travel control is underway. When the determination is negative, the control advances to step 150, and when the determination is affirmative, the control advances to step 140.

In step 140, similarly to step 140 of the first embodiment, a determination is made as to whether or not the vehicle 12 is traveling on an uphill road. When the determination is affirmative, the control advances to step 160, and when the determination is negative, the control advances to step 145. Hence, in steps 130 and 140, a similar determination to that of step 140 according to the first embodiment, or in other words a determination as to whether or not “the low speed travel control is underway and the vehicle 12 is traveling on an uphill road”, is made.

In step 145, a determination is made as to whether or not the vehicle 12 is in a travel condition of traveling over an obstacle or a travel condition of shifting from downhill travel to uphill travel. More specifically, a determination is made as to whether or not a specific condition, in which the driving forces applied to the vehicle wheels increase rapidly due to variation in the condition of the travel road such that the estimated vehicle speed calculated during execution of the low speed travel control is highly likely to equal or exceed the permission reference value, is established. When the determination is affirmative, the control advances to step 160, and when the determination is negative, the control advances to step 150. Hence, a function of determining means for determining whether or not the estimated vehicle speed Va may possibly be calculated to a larger value than the actual vehicle speed Vp due to driving slippage in the vehicle wheels caused by a rapid increase in the driving forces applied to the vehicle wheels while the low speed travel is underway is realized by steps 130 and 145.

The determination as to whether or not the vehicle 12 is in a travel condition of traveling over an obstacle may be made as described in Japanese Patent Application Publication No. 2007-315284 (JP 2007-315284 A), for example. More specifically, the vehicle may be determined to be in a travel condition of traveling over an obstacle when the estimated vehicle speed is determined to have fallen to or below a reference value while the vehicle travels under the low speed travel control. Note that the obstacle may be a step, a projection, or the like on the travel road. The determination as to whether or not the vehicle 12 is in a travel condition of shifting from downhill travel to uphill travel may be made as described in Japanese Patent Application Publication No. 2007-326427 (JP 2007-326427 A), for example. More specifically, the vehicle may be determined to be in a travel condition of shifting from downhill travel to uphill travel when it is determined that a condition in which the driving force of the vehicle is controlled to be lower than during horizontal travel has shifted to a condition in which the driving force of the vehicle is controlled to be higher than during horizontal travel in order to maintain the vehicle speed within a predetermined range.

Note that behavior control according to the fourth embodiment is executed in accordance with the flowchart shown in FIG. 4, similarly to the first embodiment.

As is evident from the above description, a determination as to whether or not “the low speed travel control is underway and the vehicle 12 is in a travel condition of traveling over an obstacle or a travel condition of shifting from downhill travel to uphill travel”, or in other words whether or not “a specific condition is established”, is made in steps 130 to 145. When the determination of step 145 is affirmative, or in other words when it is determined that “a specific condition is established”, the estimated vehicle speed Va to be used in the behavior control is set at the minimum value of the vehicle wheel speeds Vwj of the four wheels in step 160. Therefore, similarly to the first embodiment, the estimated vehicle speed Va takes a small value such that the spinning suppression control and the drift-out suppression control are unlikely to be executed. Accordingly, the driving forces applied to the vehicle wheels are less likely to be reduced during the behavior control, and as a result, the risk that the driving forces applied to the vehicle wheels will be reduced unnecessarily while the low speed travel control is underway, leading to a reduction in the vehicle speed and a corresponding reduction in the travel performance of the vehicle when traveling over an obstacle or the like, can be reduced.

### Fifth Embodiment

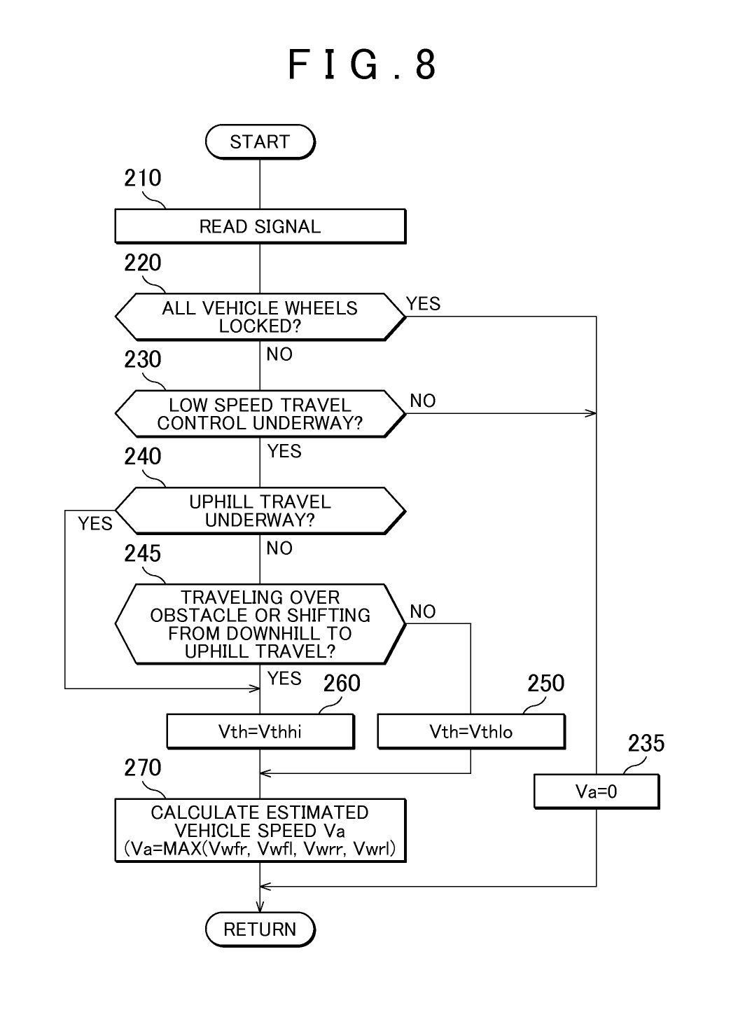

FIG. 8 is a flowchart showing a vehicle speed permission reference value control routine for determining whether or not to permit behavior control in a fifth embodiment of the travel control apparatus for a vehicle according to the invention.

Steps 210 to 245 in the routine shown in FIG. 8 are executed respectively in a similar manner to steps 110 to 145 (FIG. 7) of the fourth embodiment, while steps 250 to 270 are executed respectively in a similar manner to steps 250 to 270 (FIG. 4) of the second embodiment. Note, however, that when a negative determination is made in step 245, the control advances to step 250, and when an affirmative determination is made in step 240 or step 245, the control advances to step 260.

Note that behavior control according to the fifth embodiment is executed according to the flowchart shown in FIG. 5, similarly to the second embodiment.

As is evident from the above description, a determination as to whether or not “the low speed travel control is underway and the vehicle 12 is in a travel condition of traveling over an obstacle or a travel condition of shifting from downhill travel to uphill travel”, or in other words whether or not “a specific condition is established”, is made in steps 230 to 245. When the determination of step 245 is affirmative, or in other words when it is determined that “a specific condition is established”, the vehicle speed permission reference value Vth is set at Vthhi, which is larger than the standard value Vthlo, in step 260. Hence, similarly to the second embodiment, the determination of step 435 in FIG. 5 is more likely to be negative, and therefore execution of steps 450 to 500 can be suppressed such that the driving forces applied to the vehicle wheels are less likely to be reduced unnecessarily during the behavior control. As a result, the risk that the driving forces applied to the vehicle wheels will be reduced unnecessarily while the low speed travel control is underway, leading to a reduction in the vehicle speed and a corresponding reduction in the travel performance of the vehicle when traveling over an obstacle or the like, can be reduced.

### Sixth Embodiment

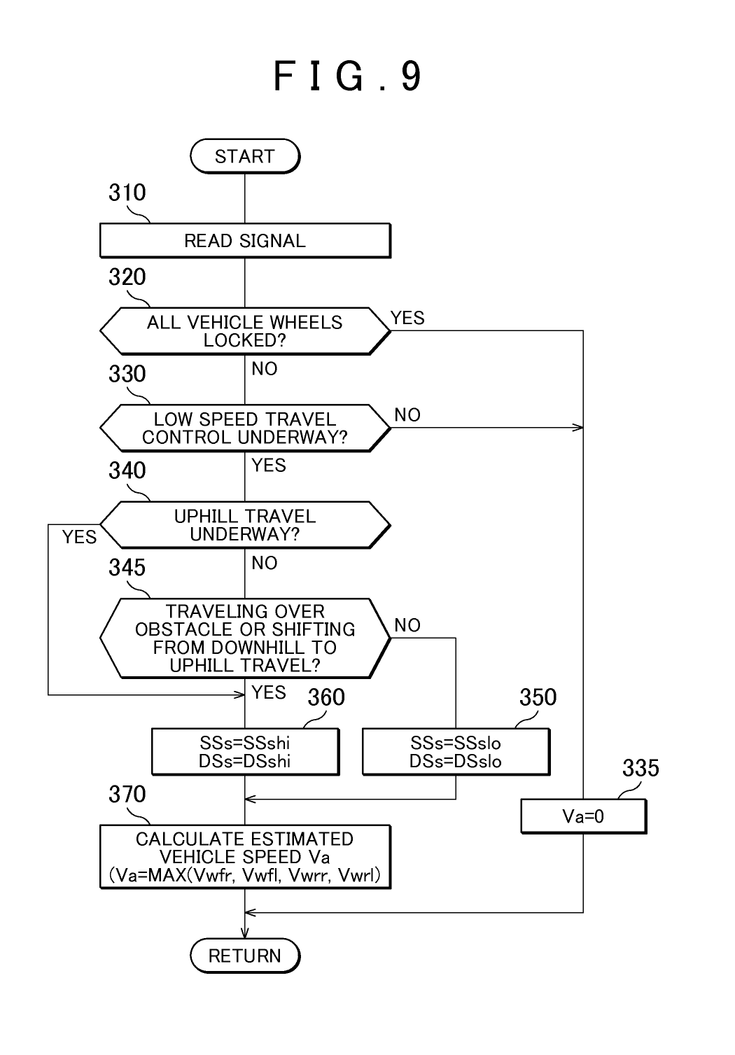

FIG. 9 is a flowchart showing a reference value control routine for determining whether or not to permit execution of spinning suppression control and drift-out suppression control as behavior control performed in a sixth embodiment of the travel control apparatus for a vehicle according to the invention.

Steps 310 to 345 in the reference value control routine according to the sixth embodiment are executed respectively in a similar manner to steps 110 to 145 (FIG. 7) of the fourth embodiment, while steps 350 to 370 are executed respectively in a similar manner to steps 350 to 370 (FIG. 6) of the third embodiment. Note, however, that when a negative determination is made in step 345, the control advances to step 350, and when an affirmative determination is made in step 340 or step 345, the control advances to step 360.

Note that behavior control according to the sixth embodiment is executed according to the flowchart shown in FIG. 4, similarly to the first embodiment.

As is evident from the above description, a determination as to whether or not “the low speed travel control is underway and the vehicle 12 is in a travel condition of traveling over an obstacle or a travel condition of shifting from downhill travel to uphill travel”, or in other words whether or not “a specific condition is established”, is made in steps 330 to 345. When the determination of step 345 is affirmative, or in other words when it is determined that “a specific condition is established”, the reference values SSs and DSs are set respectively at SSshi and DSshi, which are larger than the standard values SSslo and DSslo, in step S360. Hence, similarly to the third embodiment, the determinations of steps 460 and 490 are more likely to be negative, and therefore steps 470 and 500 are less likely to be executed. Accordingly, the driving forces applied to the vehicle wheels are less likely to be reduced during the behavior control. As a result, the risk that the driving forces applied to the vehicle wheels will be reduced unnecessarily while the low speed travel control is underway, leading to a reduction in the vehicle speed and a corresponding reduction in the travel performance of the vehicle when traveling over an obstacle or the like, can be reduced.

### Seventh Embodiment

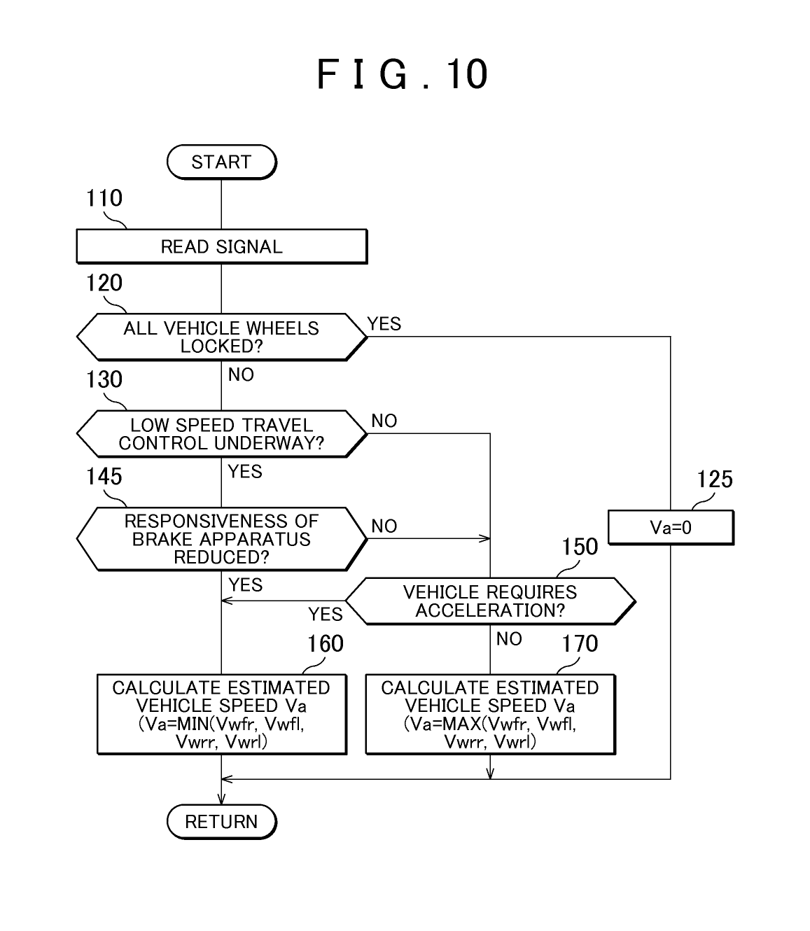

FIG. 10 is a flowchart showing an estimated vehicle speed calculation control routine performed in a seventh embodiment of the travel control apparatus for a vehicle according to the invention.

Steps 110 to 130 in the routine shown in FIG. 10 are executed respectively in a similar manner to the corresponding steps of the first embodiment.

In step 145, a determination is made as to whether or not a responsiveness of the brake apparatus 24 has decreased. In other words, a determination is made as to whether or not a specific condition, in which the vehicle wheel speeds increase temporarily due to delayed generation and increase of the braking forces such that the estimated vehicle speed calculated during execution of the low speed travel control is highly likely to equal or exceed the permission reference value, is established. When the determination is affirmative, the control advances to step 160, and when the determination is negative, the control advances to step 150. Hence, a function of determining means for determining whether or not the estimated vehicle speed Va may possibly be calculated to a value that equals or exceeds the permission reference value Vth due to a reduction in the responsiveness of the brake apparatus 24 while the low speed travel control is underway is realized by steps 130 and 145.

In this case, the responsiveness of the brake apparatus 24 may be determined to have decreased when one of following conditions d1 to d5 is satisfied. d1. Knockback has occurred in the brake apparatus 24. d2. The vehicle 12 is traveling on a bad road. d3. The vehicle 12 is traveling in an extremely low temperature.

Although not shown in FIG. 1, the brake apparatus 24 generates braking force by pushing a brake pad against a brake rotor using the internal pressure Pj of the wheel cylinders 36FR, 36FL, 36RR, and 36RL. Knockback is a phenomenon whereby a lateral force acts on the vehicle when the vehicle turns or the like such that the brake pad is pushed back by the brake rotor, with the result that an interval between the brake pad and the brake rotor takes a larger value than normal. Knockback causes a reduction in the responsiveness of the brake apparatus 24. As described in Japanese Patent Application Publication No. 2013-86626 (JP 2013-86626 A), for example, a determination as to whether or not knockback has occurred may be made by determining whether or not the lateral acceleration of the vehicle has equaled or exceeded a reference value continuously for at least a predetermined time.

Further, when the vehicle 12 travels on a bad road, the vehicle wheels receive lateral force from the travel road, and therefore, similarly to a case in which lateral force acts on the vehicle, the interval between the brake pad and the brake rotor is likely to become larger than normal (this is also referred to as kickback), resulting in a reduction in the responsiveness of the brake apparatus 24. The determination as to whether or not the vehicle 12 is travelling on a bad road may be made as described in Japanese Patent Application Publication No. 2009-202860 (JP 2013-202860 A), for example. More specifically, a differential value of the vehicle wheel speed is calculated as a vehicle wheel acceleration, whereupon the vehicle wheel acceleration is processed by a high-pass filter in order to extract a component caused by undulating variation on the road surface. A determination may then be made on the basis of an amplitude, a period, and so on of this component as to whether or not the undulating variation on the road surface is large.

Furthermore, when the vehicle 12 travels in an extremely low temperature, brake oil and lubricant serving as pressure propagation media of the brake apparatus 24 increase in viscosity such that propagation of the braking pressure is delayed in comparison with a normal temperature. As a result, the responsiveness of the brake apparatus 24 decreases. For example, the determination as to whether or not the vehicle 12 is travelling in an extremely low temperature may be made on the basis of a cooling water temperature of the engine 22, which is supplied from the drive control ECU 26, or in a case where an outside air temperature sensor is provided in the vehicle 12, the determination may be made on the basis of a detection value from the sensor.

Note that behavior control according to the seventh embodiment is executed according to the flowchart shown in FIG. 4, similarly to the first embodiment.

As is evident from the above description, a determination as to whether or not “the low speed travel control is underway and the responsiveness of the brake apparatus 24 has decreased”, or in other words whether or not “a specific condition is established”, is made in steps 130 to 145. When the determination of step 145 is affirmative, or in other words when it is determined that “a specific condition is established”, the estimated vehicle speed Va to be used in the behavior control is set at the minimum value of the vehicle wheel speeds Vwj of the four wheels in step 160. As a result, similarly to the first and fourth embodiments, the estimated vehicle speed Va takes a small value such that the spinning suppression control and the drift-out suppression control are unlikely to be executed. Accordingly, the risk that the driving forces applied to the vehicle wheels will be reduced unnecessarily during the behavior control while the low speed travel control is underway, leading to a reduction in the vehicle speed and a corresponding reduction in the travel performance of the vehicle in a condition where the responsiveness of the brake apparatus 24 has decreased, can be reduced.

### Eighth Embodiment

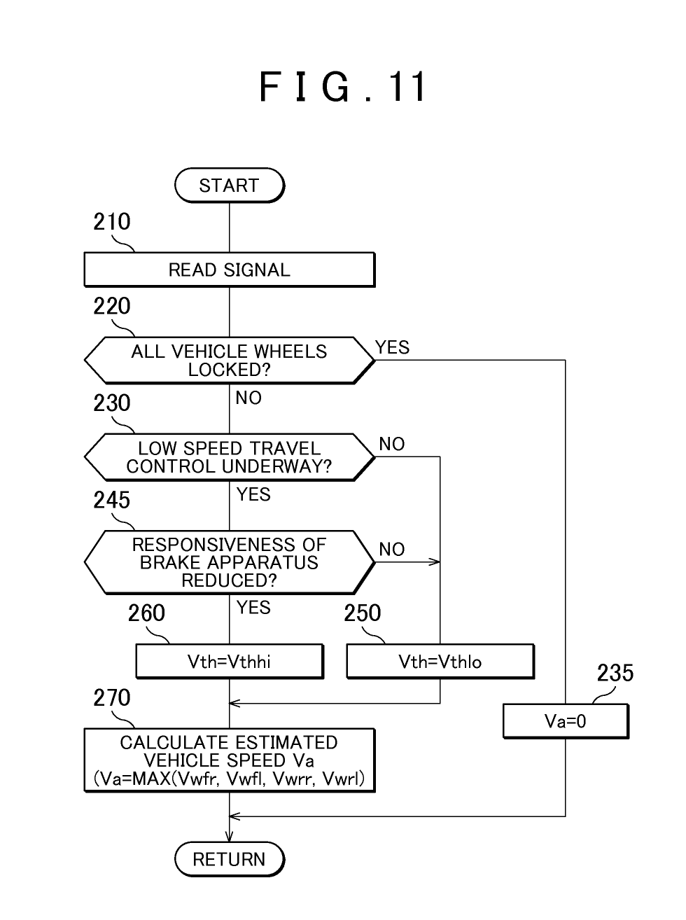

FIG. 11 is a flowchart showing a vehicle speed permission reference value control routine for determining whether or not to permit behavior control in an eighth embodiment of the travel control apparatus for a vehicle according to the invention.

Steps 210 to 245 in the routine shown in FIG. 11 are executed respectively in a similar manner to steps 110 to 145 (FIG. 10) of the seventh embodiment, while steps 250 to 270 are executed respectively in a similar manner to steps 250 to 270 (FIG. 4) of the second embodiment. Note, however, that when an affirmative determination is made in step 245, the control advances to step 260, and when a negative determination is made in step 230 or step 245, the control advances to step 250.

Note that behavior control according to the eighth embodiment is executed according to the flowchart shown in FIG. 5, similarly to the second embodiment.

As is evident from the above description, a determination as to whether or not “the low speed travel control is underway and the responsiveness of the brake apparatus 24 has decreased”, or in other words whether or not “a specific condition is established”, is made in steps 220 to 245. When the determination of step 245 is affirmative, or in other words when it is determined that “a specific condition is established”, the vehicle speed permission reference value Vth is set at Vthhi, which is larger than the standard value Vthlo, in step 260. Hence, similarly to the second and fifth embodiments, the determination of step 435 is more likely to be negative, and therefore execution of steps 450 to 500 can be suppressed. As a result, the risk that the driving forces applied to the vehicle wheels will be reduced unnecessarily during the behavior control while the low speed travel control is underway, leading to a reduction in the vehicle speed and a corresponding reduction in the travel performance of the vehicle in a condition where the responsiveness of the brake apparatus 24 has decreased, can be reduced.

### Ninth Embodiment

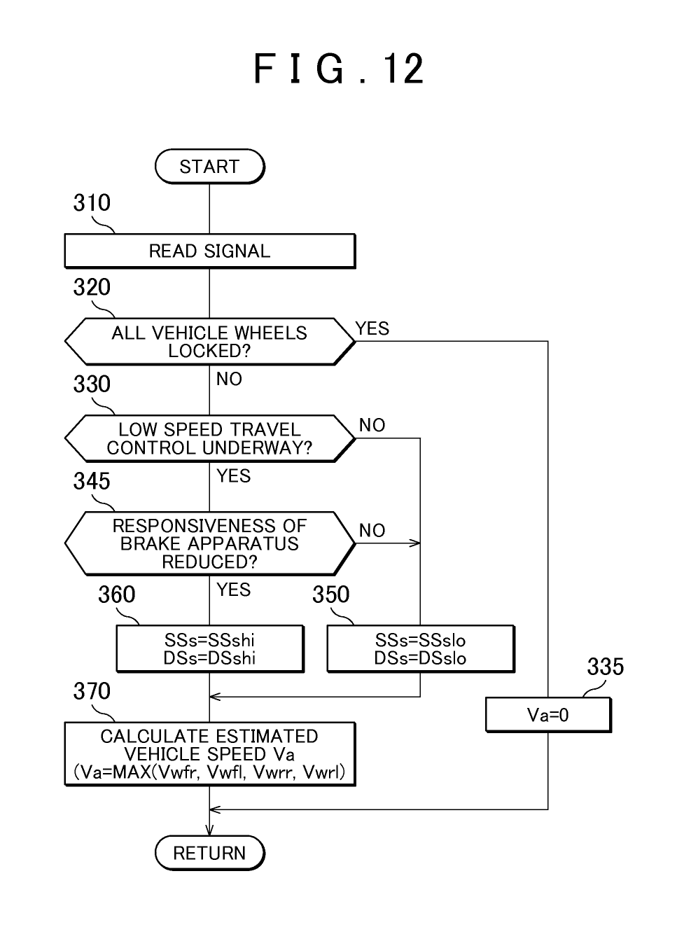

FIG. 12 is a flowchart showing a reference value control routine for determining whether or not to permit execution of spinning suppression control and drift-out suppression control as behavior control performed in a ninth embodiment of the travel control apparatus for a vehicle according to the invention.

Steps 310 to 345 of the reference value control routine according to the ninth embodiment are executed in a similar manner to steps 110 to 145 (FIG. 10) of the seventh embodiment, while steps 350 to 370 are executed in a similar manner to steps 350 to 370 (FIG. 6) of the third embodiment. Note, however, that when an affirmative determination is made in step 345, the control advances to step 360, and when a negative determination is made in step 330 or step 345, the control advances to step 350.

Note that behavior control according to the ninth embodiment is executed according to the flowchart shown in FIG. 4, similarly to the first embodiment.

As is evident from the above description, a determination as to whether or not “the low speed travel control is underway and the responsiveness of the brake apparatus 24 has decreased”, or in other words whether or not “a specific condition is established”, is made in steps 320 to 345. When the determination of step 345 is affirmative, or in other words when it is determined that “a specific condition is established”, the reference values SSs and DSs are set respectively at SSshi and DSshi, which are larger than the standard values SSslo and DSslo, in step S360. Hence, similarly to the third and sixth embodiments, the determinations of steps 460 and 490 are more likely to be negative, and therefore steps 470 and 500 are less likely to be executed. As a result, the risk that the driving forces applied to the vehicle wheels will be reduced unnecessarily during the behavior control while the low speed travel control is underway, leading to a reduction in the vehicle speed and a corresponding reduction in the travel performance of the vehicle in a condition where the responsiveness of the brake apparatus 24 has decreased, can be reduced.

Note that in the first embodiment, a negative determination is made in step 140 when the vehicle 12 is not traveling on an uphill road, even while the low speed travel control is underway. In the fourth embodiment, a negative determination is made in step 240 when the vehicle 12 is not in a travel condition of traveling over an obstacle or shifting from downhill travel to uphill travel, even while the low speed travel control is underway. Further, in the seventh embodiment, a negative determination is made in step 145 when the responsiveness of the brake apparatus 24 has not decreased, even while the low speed travel control is underway. Accordingly, the estimated vehicle speed Va is set at the maximum value of the vehicle wheel speeds Vwj of the four wheels in step 170 such that execution of the behavior control is not suppressed, and therefore, when the behavior of the vehicle deteriorates, the behavior of the vehicle can be stabilized by executing the behavior control.

Similarly, in the second embodiment, a negative determination is made in step 240 when the vehicle 12 is not traveling on an uphill road, even while the low speed travel control is underway. In the fifth embodiment, a negative determination is made in step 245 when the vehicle 12 is not in a travel condition of traveling over an obstacle or shifting from downhill travel to uphill travel, even while the low speed travel control is underway. Further, in the eighth embodiment, a negative determination is made in step 245 when the responsiveness of the brake apparatus 24 has not decreased, even while the low speed travel control is underway. Accordingly, the vehicle speed permission reference value Vth is set at the standard value Vthlo in step 250 such that execution of the behavior control is not suppressed, and therefore, when the behavior of the vehicle deteriorates, the behavior of the vehicle can be stabilized by executing the behavior control.

Furthermore, in the third embodiment, a negative determination is made in step 340 when the vehicle 12 is not traveling on an uphill road, even while the low speed travel control is underway. In the sixth embodiment, a negative determination is made in step 345 when the vehicle 12 is not in a travel condition of traveling over an obstacle or shifting from downhill travel to uphill travel, even while the low speed travel control is underway. Further, in the ninth embodiment, a negative determination is made in step 345 when the responsiveness of the brake apparatus 24 has not decreased, even while the low speed travel control is underway. Accordingly, the reference values SSs and DSs are set respectively at the standard values SSslo and DSslo in step 350 such that execution of the behavior control is not suppressed, and therefore, when the behavior of the vehicle deteriorates, the behavior of the vehicle can be stabilized by executing the behavior control.

Specific embodiments of the invention were described in detail above, but the invention is not limited to the above embodiments, and various other possible embodiments within the scope of the invention will be evident to persons skilled in the art.

For example, in the above embodiments, the normal estimated vehicle wheel speed Va is calculated to the maximum value of the vehicle wheel speeds of the four wheels. However, as long as the normal estimated vehicle wheel speed Va is based on a value other than the minimum value of the vehicle wheel speeds of the four wheels, and preferably based on at least the maximum value, an average value of the maximum value and the second largest value, for example, may be used instead. In a case where the first, fourth, and seventh embodiments are amended in accordance with this example, the calculation method is amended such that when the specific condition is determined to be established, the estimated vehicle wheel speed Va is calculated to a smaller value than the normal estimated vehicle wheel speed.

Further, in the above embodiments, the vehicle speed reference value used in the condition for terminating the vehicle behavior control is identical to the vehicle speed reference value used in the condition for permitting the vehicle behavior control, but the two reference values may be different. In particular, the vehicle speed reference value used in the termination condition may be set at a smaller value than the vehicle speed reference value used in the permission condition.

Furthermore, in the above embodiments, the vehicle speed (referred to as Vx) used to calculate the spinning state quantity SS and the drift-out state quantity DS is identical to the estimated vehicle speed Va used to determine whether or not to permit the vehicle behavior control, but the vehicle speed Vx may take a different value to the estimated vehicle speed Va. For example, when the estimated vehicle speed Va is set at the minimum value of the vehicle wheel speeds Vwj of the four wheels, the vehicle speed Vx may be an average value of the minimum value and the second smallest value of the vehicle wheel speeds Vwj of the four wheels. Similarly, when the estimated vehicle speed Va is set at the maximum value of the vehicle wheel speeds Vwj of the four wheels, the vehicle speed Vx may be an average value of the maximum value and the second largest value of the vehicle wheel speeds Vwj of the four wheels.

Moreover, in the first, fourth, and seventh embodiments, the estimated vehicle speed Va is set at the maximum value of the vehicle wheel speeds Vwj of the four wheels when the determinations of steps 140 and 150 are negative, and set at the minimum value of the vehicle wheel speeds Vwj of the four wheels when the determination of step 140 or the determination of step 150 is affirmative. However, the estimated vehicle speed Va in a case where the determination of step 140 is affirmative may be calculated using another method as long as it is calculated to a smaller value than the estimated vehicle speed in a case where the determinations of steps 140 and 150 are negative. For example, the estimated vehicle speed Va in a case where the determination of step 140 is affirmative may be an average value of the minimum value and the second smallest value of the vehicle wheel speeds Vwj of the four wheels, similarly to the case of the vehicle speed Vx described above, an average value of the three vehicle wheel speeds other than the maximum value of the vehicle wheel speeds Vwj of the four wheels, or a value obtained by multiplying a correction coefficient that is larger than 0 and smaller than 1 by the maximum value or one of the average values described above.

Furthermore, in the third, sixth, and ninth embodiments, the reference values SSs and DSs are set respectively at SSshi and DSshi, which are larger than the standard values SSslo and DSslo, when it is determined that the low speed travel control is underway and the vehicle 12 is traveling uphill or the like. Instead, however, the spinning state quantity SS and/or the drift-out state quantity DS may be corrected so as to decrease when it is determined that the low speed travel control is underway and the vehicle 12 is traveling uphill or the like, and in so doing, similar effects are obtained to a case in which the reference values SSs and/or DSs are amended to larger values. Alternatively, the reference values SSs and/or DSs may be amended to larger values as well as correcting the spinning state quantity SS and/or the drift-out state quantity DS so as to decrease.

Moreover, in the fourth to sixth embodiments, a determination as to whether or not the vehicle 12 is traveling on an uphill road is made respectively in steps 140, 240, and 340, but these steps may be omitted.

Furthermore, in the above embodiments, the estimated vehicle speed Va is calculated by the integrated control ECU 52 of the integrated control apparatus 18, but the integrated control apparatus 18 may be omitted such that the estimated vehicle speed Va is calculated by the drive control ECU 26 or the vehicle behavior control apparatus 16. Moreover, in this case, a function as uphill condition detecting means and a function as amending means for amending the behavior control such that the driving forces applied to the vehicle wheels are less likely to be reduced during the behavior control are realized by the drive control ECU 26 or the vehicle behavior control apparatus 16.

Furthermore, in the above embodiments, the spinning suppression control and the drift-out suppression control are both performed as the vehicle behavior control. However, either one of the spinning suppression control and the drift-out suppression control may be performed as the vehicle behavior control.

Moreover, configurations described in the first to ninth embodiments may be implemented in desired combinations, and the travel control apparatus of the invention may be applied to a front-wheel-drive vehicle or a rear-wheel-drive vehicle instead of a four-wheel-drive vehicle.

For example, the behavior control may be amended such that the driving forces applied to the vehicle wheels are less likely to be reduced during the behavior control by reducing the estimated vehicle speed and increasing the permission reference value in comparison with a case where it is determined that the low speed travel control is not underway or that there is no risk that the estimated vehicle speed will be calculated to a larger value than the actual vehicle speed.

Furthermore, in a case where stabilization of the vehicle travel behavior is determined to be required when the index value indicating instability in the vehicle travel behavior equals or exceeds the determination reference value, and the driving forces applied to the vehicle wheels are reduced by performing the behavior control when stabilization of the vehicle travel behavior is determined to be required, the behavior control may be amended such that the driving forces applied to the vehicle wheels are less likely to be reduced during the behavior control by increasing the permission reference value and the determination reference value in comparison with a case where it is determined that the low speed travel control is not underway or that the risk described above does not exist.

Moreover, in a case where stabilization of the vehicle travel behavior is determined to be required when the index value indicating instability in the vehicle travel behavior equals or exceeds the determination reference value, and the driving forces applied to the vehicle wheels are reduced by performing the behavior control when stabilization of the vehicle travel behavior is determined to be required, the behavior control may be amended such that the driving forces applied to the vehicle wheels are less likely to be reduced during the behavior control by performing at least two of modifying the method of calculating the estimated vehicle speed such that the estimated vehicle speed is calculated to a smaller value, increasing the permission reference value, and increasing the determination reference value in comparison with a case where it is determined that the low speed travel control is not underway or that the risk described above does not exist.

What is claimed is:

1. A travel control apparatus comprising:
a low speed travel apparatus that performs low speed travel control, in which a vehicle is caused to travel at a low speed, by controlling a braking/driving force of the vehicle without the need for a driver to perform a braking/driving operation;
a vehicle behavior control apparatus that calculates an estimated vehicle speed on the basis of a vehicle wheel speed, and performs behavior control to stabilize travel behavior of the vehicle by reducing a driving force applied to a vehicle wheel when stabilization of the travel behavior of the vehicle is determined to be required in a condition where the estimated vehicle speed equals or exceeds a permission reference value;
a determination unit that determines whether or not a specific condition, in which the estimated vehicle speed is highly likely to equal or exceed the permission reference value during execution of the low speed travel control even though an actual vehicle speed of the vehicle is lower than the permission reference value, is established; and
an amendment unit that amends the behavior control such that the driving force applied to the vehicle wheel is less likely to be reduced during the behavior control when the specific condition is determined to be established.

2. The travel control apparatus according to claim 1, wherein the determination unit determines whether or not the specific condition is established by determining whether or not the vehicle is traveling on an uphill road during execution of the low speed travel control.

3. The travel control apparatus according to claim 1, wherein the determination unit determines whether or not the specific condition is established by determining whether or not a travel condition, in which the driving force applied to the vehicle wheel during the low speed travel control is highly likely to be increased at an increase rate equaling or exceeding a predetermined increase rate, is established.

4. The travel control apparatus according to claim 1, wherein the determination unit determines whether or not the specific condition is established by determining whether or not a reduced responsiveness condition, in which a responsiveness of a brake apparatus that applies a braking force to the vehicle wheel has decreased, is established during execution of the low speed travel control.

5. The travel control apparatus according to claim 1, wherein the amendment unit amends the behavior control by modifying a method of calculating the estimated vehicle speed such that the estimated vehicle speed is calculated to a smaller value than when the specific condition is determined not to be established.

6. The travel control apparatus according to claim 1, wherein the amendment unit amends the behavior control by increasing the permission reference value in comparison with a case where the specific condition is determined not to be established.

7. The travel control apparatus according to claim 1, wherein the vehicle behavior control apparatus calculates an index value indicating instability in the travel behavior of the vehicle, and determines that stabilization of the travel behavior of the vehicle is required when the index value equals or exceeds a determination reference value, and
the amendment unit amends the behavior control by increasing the determination reference value in comparison with a case where the specific condition is determined not to be established.

8. A vehicle control apparatus comprising:
a low speed travel apparatus that performs travel control, in which a vehicle is caused to travel at a low speed, by controlling a braking/driving force of the vehicle;
a vehicle behavior control apparatus that calculates an estimated vehicle speed on the basis of a vehicle wheel speed, and performs behavior control to stabilize travel behavior of the vehicle by reducing a driving force applied to a vehicle wheel when stabilization of the travel behavior of the vehicle is determined to be required in a condition where the estimated vehicle speed equals or exceeds a permission reference value; and
an integrated control apparatus that determines whether or not a specific condition, in which the calculated estimated vehicle speed is highly likely to equal or exceed the permission reference value during execution of the low speed travel control even though an actual vehicle speed of the vehicle is lower than the permission reference value, is established, and amends the behavior control so that the driving force applied to the vehicle wheel is less likely to be reduced during the behavior control when the specific condition is determined to be established.
